(19) United States
(12) Patent Application Publication
(10) Pub. No.: US 2011/0182244 A1
(43) Pub. Date: Jul. 28, 2011

(54) METHOD FOR SUPPORTING CONTEXT MANAGEMENT BY HOME NODE-B

(75) Inventors: Huarui Liang, Beijing (CN); Tae-sun Yeoum, Seoul (KR); Xiaoqiang Li, Beijing (CN)

(73) Assignees: SAMSUNG ELECTRONICS CO., LTD., Suwon-city, Gyeonggi-do (KR); BEIJING SAMSUNG TELECOM R&D CENTER, Beijing (CN)

(21) Appl. No.: 13/120,798

(22) PCT Filed: Sep. 11, 2009
(86) PCT No.: PCT/KR2009/005179

§ 371 Date: Mar. 24, 2011

(30) Foreign Application Priority Data
Sep. 24, 2008 (CN) 200810161539.X

(51) Int. Cl. H04W 4/00

(52) U.S. Cl. 370/328

(57) ABSTRACT

A method for managing user context by a Home evolved NodeB (HeNB) is provided. The method includes requesting, by a Mobility Management Entity (MME), the HeNB to reserve a first type of User Equipment (UE) context information, obtaining, by the HeNB, the MME of the UE according to the first type of UE context information after receiving data, and notifying, by the HeNB, the MME of an arrival of the data. With the method according to the present invention, it is guaranteed by an HeNB system that a terminal can receive downlink signaling after activation of a local routing optimization service by the terminal.

### PRIORITY

This application is a National Stage application under 35 U.S.C. §371 of an International application filed on Sep. 11, 2009 and assigned application No. PCT/KR2009/005179, and claims the benefit under 35 U.S.C. §365(b) of a Chinese patent application filed Sep. 24, 2008 in the Chinese Intellectual Property Office and assigned application No. 200810161539.X, the entire disclosure of which is hereby incorporated by reference.

### BACKGROUND OF THE INVENTION

1. Field of the Invention

The present invention relates to the communication field. More particularly, the present invention relates to a method for managing a User Equipment (UE) context by a Home evolved NodeB (HeNB).

2. Description of Related Art

FIG. 1 depicts the system structure of System Architecture Evolution (SAE) according to the related art.

Referring to FIG. 1, a User Equipment (UE) 101 is a terminal device for receiving data. An Evolved Universal Mobile Telecommunication System (UMTS) Terrestrial Radio Access Network (EUTRAN) 102, also referred to as an evolved NodeB (eNB), is a radio access network of System Architecture Evolution (SAE) for providing an interface through which a Long Term Evolution (LTE) mobile phone can access a radio network. The EUTRAN 102 is connected to a Mobility Management Entity (MME) 103 of the mobile phone and a serving gateway 104, which is a user plane entity, through an S1 interface. The MME 103 is used to manage a mobility context and a session context of the UE and to store user information on security. The serving gateway 104 primarily provides user plane functionality. An S1-MME interface is used to provide the UE with radio access bearer setup and to forward messages transmitted from the UE to the MME over the radio access network. The combined function of the MME 103 and the serving gateway 104 is similar to that of the original Serving General Packet Radio Service (GPRS) Support Node (SGSN) 108. It is possible that both the MME and the serving gateway are located at a common physical entity. A Public Data Network (PDN) gateway 105 is responsible for functions such as billing, lawful interception, and the like. In addition, it is possible that both the serving gateway and the PDN gateway are located at a common physical entity. A SGSN 108 is used to provide routing for data transmission in the existing UMTS. The existing SGSN finds a corresponding Gateway General Packet Radio Service (GPRS) Support Node (GGSN) according to an Access Point Name (APN). A Home Subscriber Server (HSS) 109 is a home subscriber sub-system for the UE, configured to store user information such as a current location of the UE, the address of the serving node, user information on security, Packet Data Protocol (PDP) context activated by the UE, and the like. A Policy and Charging Rules Function (PCRF) 106 provides a Quality of Service (QoS) policy and billing rules through an S7 interface.

So far, a Home eNB (HeNB) system resides in the EUTRAN 102. It is not yet determined whether or not an HeNB system should comprise two nodes, an HeNB and an HeNB Gateway (HeNB-GW). The HeNB is deployed in a user's home, while the HeNB-GW is deployed in an operator network if there is the HeNB-GW in the HeNB system. However, there is no final agreement on a specific functionality partition for the HeNB and Home Gateway (H-GW). According to the latest discussion, it is likely that the H-GW exists in an HeNB system, and it is thus an S1 Application Protocol (S1-AP) message should be transmitted from the Home Node-B (HNB) to the H-GW from which the message is forwarded to the MME.

The HeNB supports a function of local routing optimization, including accessing the Internet directly by the HeNB without passing through any core network node, such that the routing for user data can be reduced. If the HeNB supports the local routing optimization function, it is necessary to add respective functions of Serving Gateway (S-GW) and PDN Gateway (P-GW) to the HeNB. Further, the HeNB, S-GW and P-GW can be located at a common physical entity.

In the related art, there is no specific definition in current specifications with respect to the functionality of the Home Evolved Node-B (eNB) (HeNB) for supporting local routing optimization. According to existing specifications, when a terminal is transferred from an active state to an idle state, it is necessary for the HeNB to release all context information associated with the User Equipment (UE). In such a case, however, a UE belonging to the HeNB cannot be paged. The present invention provides a method for paging an idle terminal when the HeNB supports the local routing optimization function.

### SUMMARY OF THE INVENTION

Aspects of the present invention are to address at least the above-mentioned problems and/or disadvantages and to provide at least the advantages described below. Accordingly, an aspect of the present invention is to provide a method for managing user context by an HeNB, and which is capable of guaranteeing a terminal to receive downlink signaling, such as paging, from an HeNB system when the HeNB system provides local routing optimization.

According to an aspect of the present invention, a method for managing user context by an HeNB is provided. The method includes requesting, by a Mobility Management Entity (MME), the HeNB to reserve a first type of UE context information, obtaining, by the HeNB, the MME of the UE according to the first type of UE context information after receiving data, and notifying, by the HeNB, the MME of an arrival of the data.

With an aspect of the present invention, it is guaranteed by an HeNB system that a terminal can receive downlink signaling after an activation of a local routing optimization service by the terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 shows a network structure for a System Architecture Evolution (SAE) system according to the related art;

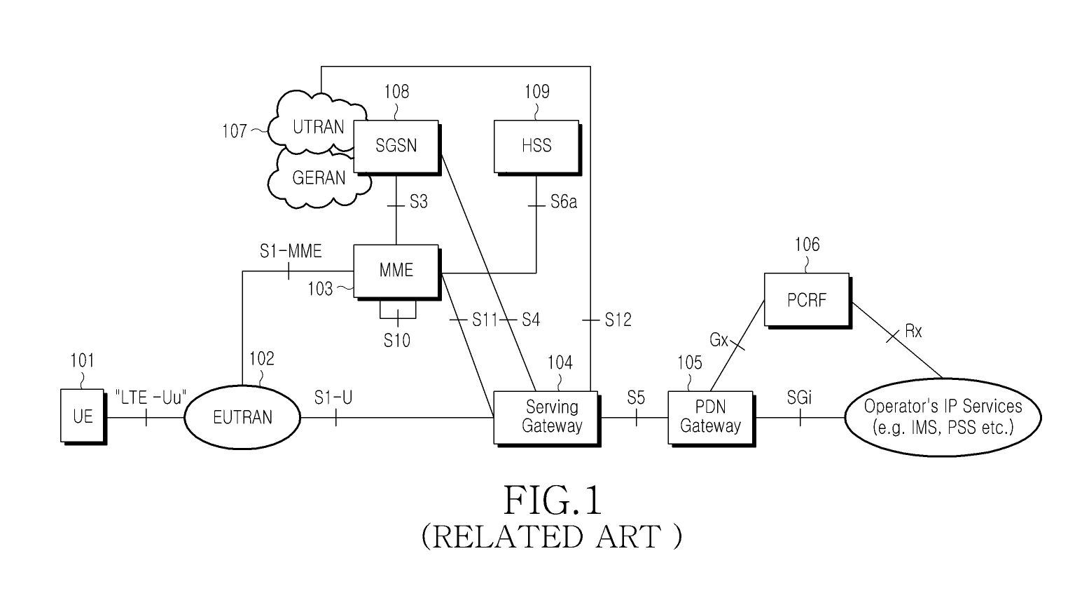

FIG. 2 shows a first flow diagram for releasing an interface S1 according to an exemplary embodiment of the present invention;

FIG. 3 shows a second flow diagram for releasing the interface S1 according to an exemplary embodiment of the present invention;

FIG. 4 shows a third flow diagram for releasing the interface S1 according to an exemplary embodiment of the present invention;

FIG. 5 shows interaction between a Mobility Management Entity (MME) and a Home Evolved Node-B (eNB)(HeNB)/Home Gateway (H-GW) according to an exemplary embodiment of the present invention;

FIG. 6 shows a flow diagram for paging a terminal in an HeNB system according to an exemplary embodiment of the present invention;

FIG. 7 shows a flow diagram in which a User Equipment (UE) moves from an HeNB area to a macro eNB area according to an exemplary embodiment of the present invention; and

FIG. 8 shows a process for activating local routing optimization service according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

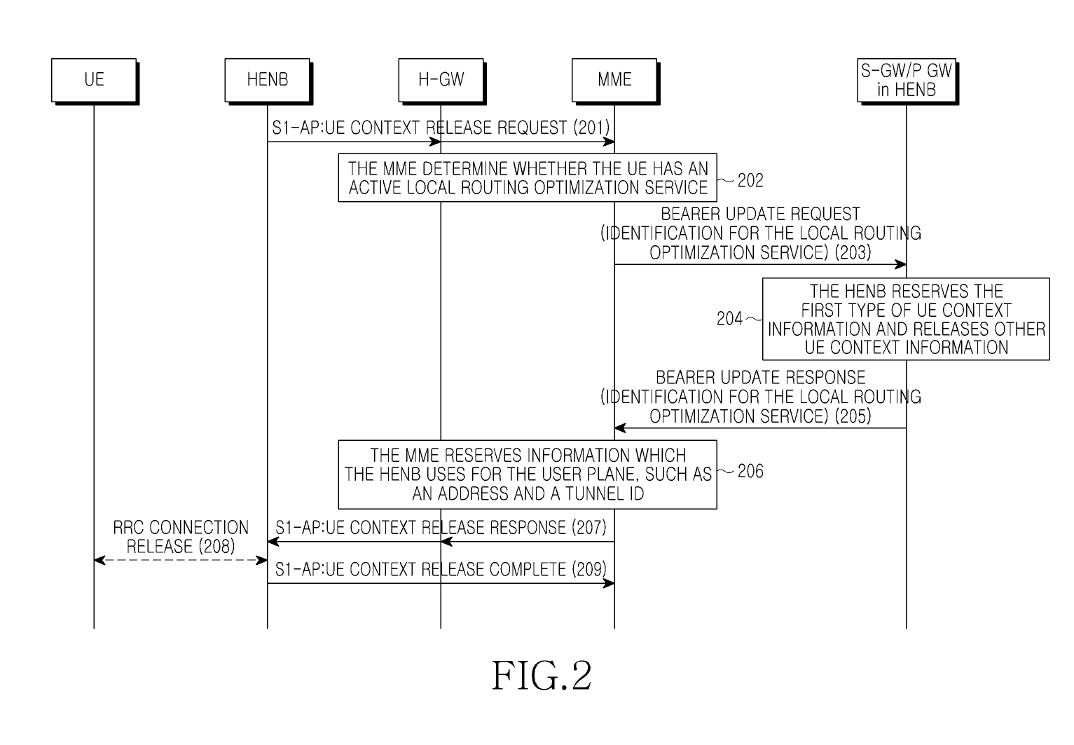

FIG. 2 is a flow diagram for releasing an interface S1 according to an exemplary embodiment of the present invention.

Referring to FIG. 2, technical details irrelevant to the present disclosure are omitted for conciseness in explanation. In the dashed block shown in FIG. 2, a logical entity, Serving Gateway (S-GW)/Public Data Network (PDN) Gateway (P-GW) in Home Evolved Node-B (eNB) (HeNB), refers to an S-GW/P-GW functional module in an HeNB entity.

At step 201, upon detecting a disconnection of an air interface, the HeNB triggers a release of the S1 connection and transmits a User Equipment (UE) context release request message to the Home Gateway (H-GW) from which the S1 Application Protocol (S1-AP) message is forwarded to the Mobility Management Entity (MME). If there is no H-GW in the Long Term Evolution (LTE) HeNB architecture, the S1-AP message is directly transmitted from the HNB to the MME. UE context information stored in the HeNB can be classified into two types, a first type being session management context information which includes an Evolved Packet System (EPS) bearer context information corresponding to the S-GW and the P-GW, and a second type being non-session management context information/mobility management context information. When a terminal is transferred from an active state to an idle state, the HeNB only releases the second type of mobility management context while reserving the first type of session management context based on an active local routing optimization service, such that the terminal can be guaranteed to receive downlink signaling.

At step 202, the MME determines whether the UE has an active local routing optimization service based on the UE context.

At step 203, based on the determination that the UE has an active local routing optimization service, the MME transmits to the HeNB a bearer update request message carrying identification indicating the support for the local routing optimization service.

At step 204, the HeNB reserves the first type of UE context information, based on the identification, and releases other UE context information.

At step 205, the HeNB transmits to the MME a bearer update response message which includes the identification indicating the support for the local routing optimization service if the HeNB has reserved the first type of UE context information. However, this identification is optional. The MME can reserve information which the HeNB uses for the user plane, such as an address and a tunnel Identification (ID), directly based on the user context information.

At step 206, after receiving the response message, the MME reserves the information which the HeNB uses for the user plane, such as an address and a tunnel ID.

At step 207, the MME transmits an S1-AP: UE context release response message to the HeNB in order to request the release of the S1 connection. The S1-AP message is first transmitted to the H-GW from which the message is forwarded to the Home Node-B (HNB). If there is no H-GW in the LTE HeNB architecture, the S1-AP message is directly transmitted from the HNB to the MME.

At step 208, a process for releasing a Radio Resource Control (RRC) connection is performed, details of which are omitted herein as being identical to the related art.

At step 209, the HeNB transmits a UE context release complete message to the MME to confirm the completion of the S1 connection release.

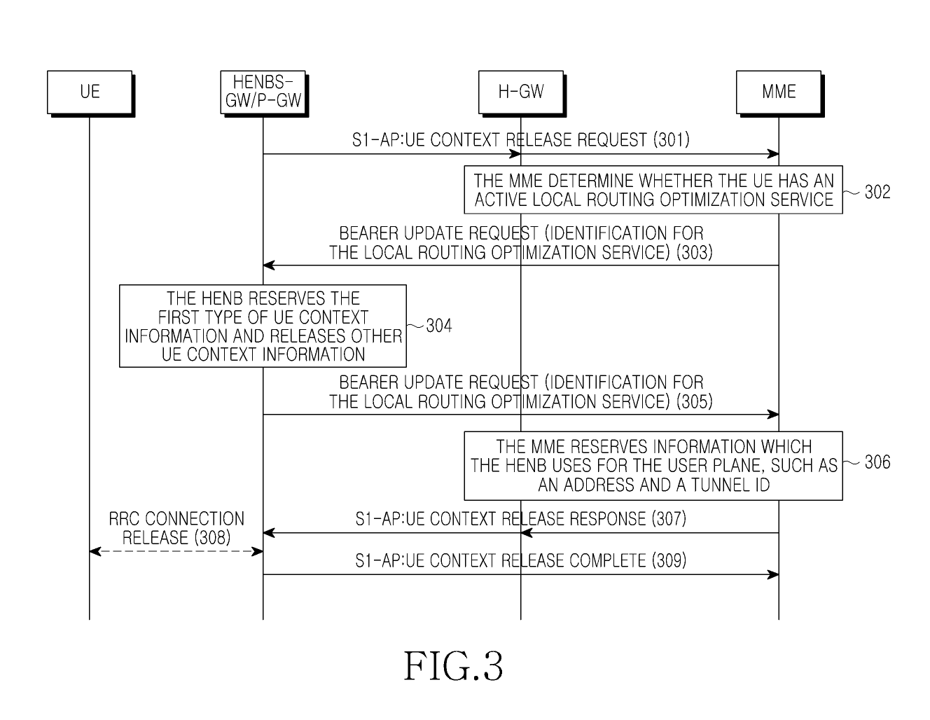

FIG. 3 is a flow diagram for releasing an interface S1 according to an exemplary embodiment of the present invention.

Referring to FIG. 3, the following description is given in which technical details irrelevant to the present disclosure are omitted for conciseness in explanation.

The first and second exemplary embodiments are two alternatives both applicable to the S1 release procedure when the UE is transferred from an active state to an idle state.

The first and second exemplary embodiments each comprise an H-GW node. However, the signaling in the respective procedures does not involve the H-GW node, since the messages transmitted from the HeNB to H-GW are the same as the messages transmitted from the HeNB to the MME.

At step 301, upon detecting a disconnection of an air interface, the HeNB triggers the release of the S1 connection and transmits a UE context release request message to the H-GW from which the S1-AP message is forwarded to the MME. If there is no H-GW in the LTE HeNB architecture, the S1-AP message is directly transmitted from the HNB to the MME.

At step 302, the MME determines whether the UE has an active local routing optimization service based on the UE context.

At step 303, based on the fact that the UE has an active local routing optimization service, the MME transmits to the HeNB a bearer update request message carrying identification indicating the support for the local routing optimization service.

At step 304, the HeNB reserves a first type of UE context information based on the identification and releases other UE context information.

At step 305, the HeNB transmits to the MME a bearer update response message which includes the identification indicating the support for the local routing optimization service if the HeNB has reserved the first type of UE context information. However, this identification is optional. The MME can reserve information which the HeNB uses for the user plane, such as an address and a tunnel ID, directly based on the user context information.

At step 306, after receiving the response message, the MME reserves the information which the HeNB uses for the user plane, such as an address and a tunnel ID.

At step 307, the MME transmits a S1-AP: UE context release response message to the HeNB in order to request the release of the S1 connection. The S1-AP message is first transmitted to the H-GW from which the message is forwarded to the HNB. If there is no H-GW in the LTE HeNB architecture, the S1-AP message is directly transmitted from the HNB to the MME.

At step 308, a process for releasing RRC connection is performed, whose details are omitted herein as being identical to the related art.

At step 309, the HeNB transmits a UE context release complete message to the MME to confirm the completion of S1 connection release. The S1-AP message is first transmitted to the H-GW from which the message is forwarded to the HNB. If there is no H-GW in the LTE HeNB architecture, the S1-AP message is directly transmitted from the HNB to the MME.

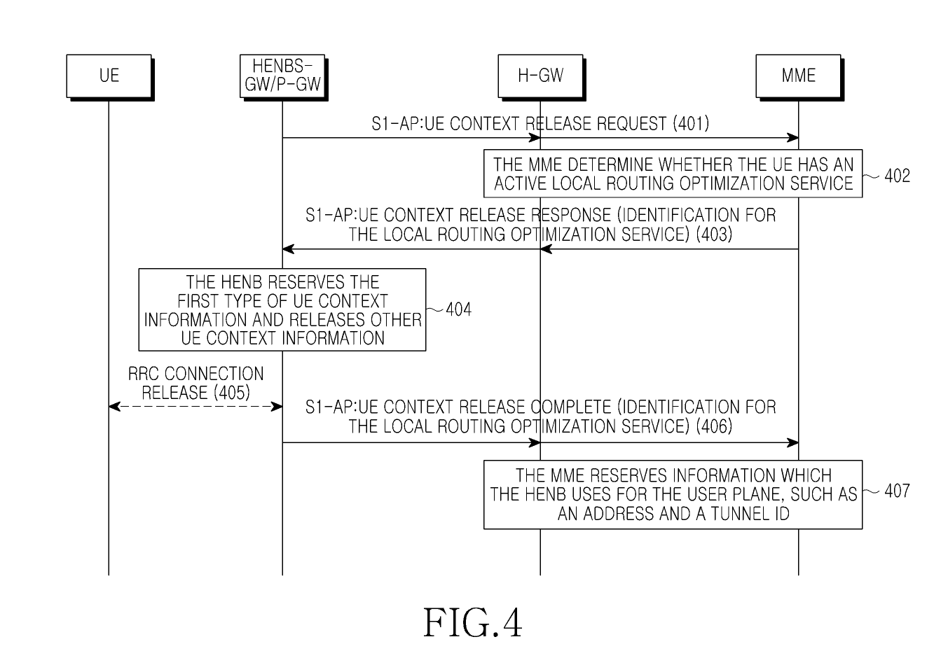

FIG. 4 is a flow diagram for releasing interface Si according to an exemplary embodiment of the present invention.

Referring to FIG. 4, the following description is given, in which technical details irrelevant to the present disclosure are omitted for conciseness in explanation.

The first, second and third exemplary embodiments are alternate schemes all applicable to the S1 release procedure when the UE transits from an active state to an idle state.

The first, second and third exemplary embodiments each comprise an H-GW node. However, the signaling in the respective procedures does not involve the H-GW node, since the messages transmitted from the HeNB to H-GW are the same as the messages transmitted from the HeNB to the MME.

At step 401, upon detecting a disconnection of an air interface, the HeNB triggers a release of the S1 connection and transmits a UE context release request message to the MME.

At step 402, the MME determines whether the UE has an active local routing optimization service based on the UE context.

At step 403, based on a determination that the UE has an active local routing optimization service, the MME transmits to the HeNB a bearer update request message carrying identification indicating the support for the local routing optimization service.

At step 404, the HeNB reserves a first type of UE context information based on the identification and releases other UE context information.

At step 405, a process for releasing an RRC connection is performed, whose details are omitted herein as being identical to the related art.

At step 406, the HeNB transmits to the MME a UE context release complete message carrying identification indicating the support for the local routing optimization service, in order to confirm the completion of the S1 connection release. However, this identification is optional. The MME can reserve information which the HeNB uses for the user plane, such as an address and a tunnel ID, directly based on the user context information.

At step 407, after receiving the response message, the MME reserves the information which the HeNB uses for the user plane, such as an address and a tunnel ID.

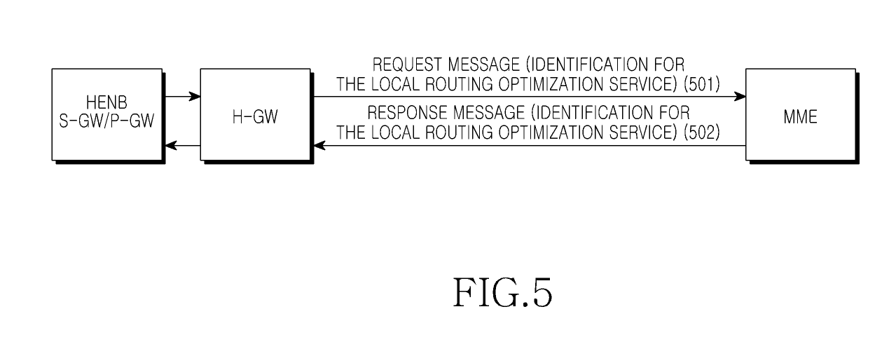

FIG. 5 shows interaction between an MME and a HeNB/H-GW according to an exemplary embodiment of the present invention.

According to an exemplary embodiment of the present invention, an interaction between the HeNB/H-GW and the MME is further described as supplement to the interface S1 release procedures according to the preceding exemplary embodiments. In this exemplary embodiment, a processing mechanism for supporting the release procedure by the MME and the HeNB is described.

Either the MME or the HeNB may determine whether the HeNB should reserve the first type of UE context information.

The MME may make the following decisions.

Referring to FIG. 5, at step 501, upon determining that the UE has an active local routing optimization service, the MME determines that the HeNB should reserve a first type of UE context information. The MME transmits a request message to the HeNB requesting the HeNB to reserve the first type of UE context information.

This message is applied in steps 202-203 of the first exemplary embodiment, steps 302-303 of the second exemplary embodiment, and steps 402-403 of the third exemplary embodiment.

At step 502, the HeNB receives the request message carrying identification indicating the support for the local routing optimization, based on which the HeNB reserves the first type of UE context information.

This message is applied in step 204 of the first exemplary embodiment, step 304 of the second exemplary embodiment and step 404 of the third exemplary embodiment.

The HeNB may also make the following decisions.

At step 501, upon determining that the UE has an active local routing optimization service, the MME transmits to the HeNB a request message carrying identification indicating the support for the local routing optimization.

This message is applied in steps 202-203 of the first exemplary embodiment, steps 302-303 of the second exemplary embodiment and steps 402-403 of the third exemplary embodiment.

At step 502, the HeNB receives the request message including the identification, and determines to reserve the first type of UE context information.

This message is applied in step 204 of the first exemplary embodiment, step 304 of the second exemplary embodiment, and step 404 of the third exemplary embodiment.

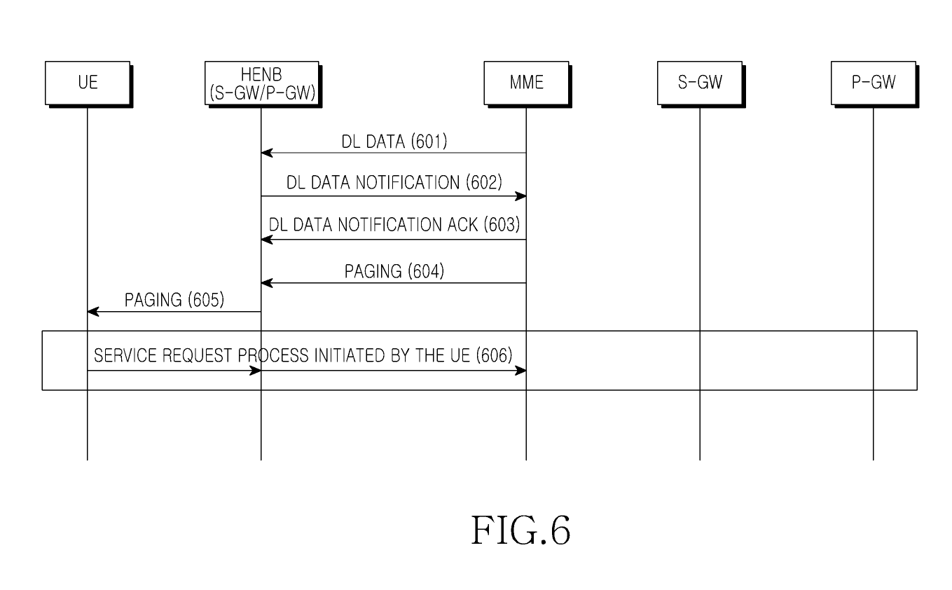

FIG. 6 is a paging flow diagram initiated by the local HeNB according to an exemplary embodiment of the present invention.

Referring to FIG. 6, the following description is given, in which technical details irrelevant to the present disclosure are omitted for conciseness in explanation.

At step 601, if the HeNB supports the local routing optimization service and reserves a first type of UE context information when the UE transits back to the idle state, downlink data can be directly transmitted to the HeNB.

At step 602, the HeNB transmits a downlink data notification to the corresponding MME according to an identification of the UE.

At step 603, the MME replies a downlink data notification acknowledgement message to the HeNB.

At step 604, the MME transmits a paging request to the HeNB if the UE context information is stored in the MME.

At step 605, after receiving the paging request, the HeNB directly initiates a UE paging process if it determines the corresponding UE context information according to the identification of the UE.

At step 606, after receiving a paging message, the UE initiates a service request process whose description is omitted herein as being identical to that defined in existing specifications.

There are different possibilities for the paging process initiated by the local HeNB with the sixth exemplary embodiment being one possibility and a seventh exemplary embodiment being another.

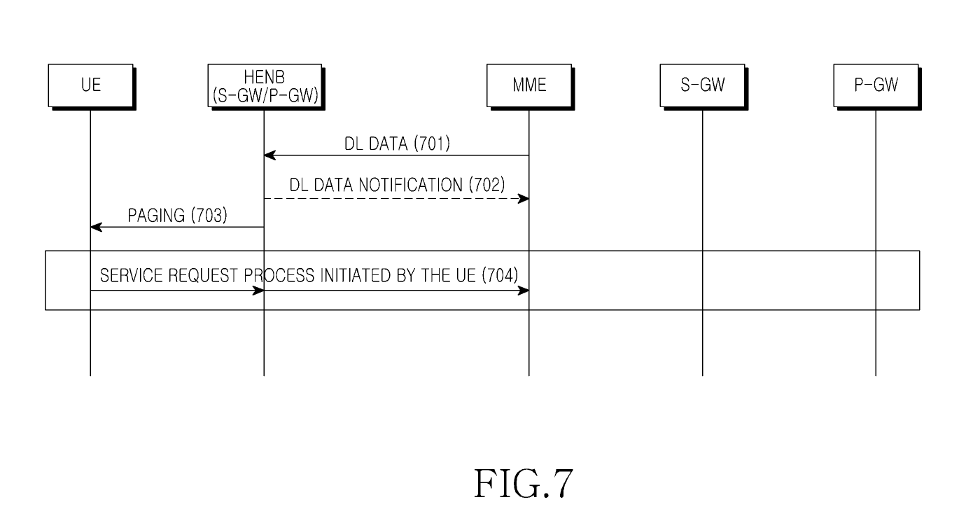

FIG. 7 shows a flow diagram in which a User Equipment (UE) moves from an HeNB area to a macro eNB area according to an exemplary embodiment of the present invention.

At step 701, if the HeNB supports the local routing optimization service and reserves a first type of UE context information when the UE is transferred back to the idle state, downlink data can be directly transmitted to the HeNB.

At step 702, the HeNB transmits a downlink data notification to the corresponding MME according to an identification of the UE. This step is optional and can be skipped if it is not required to update the UE context information in the MME.

At step 703, the HeNB pages the UE in its area.

At step 704, the UE initiates a service request process based on the receipt of the paging message.

According to an exemplary embodiment of the present invention, a scenario in which a UE moves to a macro eNB is described. In this case, there is UE context information in both a P-GW and an HeNB supporting local routing optimization service according to an exemplary embodiment of the present invention. The process for paging a UE in such case is illustrated in FIG. 7.

When the UE is transferred back to an idle state, there are two possibilities if the UE moves from the HeNB area to a macro eNB area as illustrated in FIG. 7, either a Tracking Area Update (TAU) procedure occurs or the TAU procedure does not occur. If the HeNB reserves a first type of UE context information in both cases, downlink data may be transmitted to both the HeNB and the P-GW when the UE moves to the macro eNB area. In this way, both processes for paging a UE according to the sixth exemplary embodiment and according to the existing procedure may be performed. Therefore, there is redundancy in signaling to the MME. Thus, the following optimization for the paging process is considered.

When a TAU procedure occurs in the UE and the MME transmits an S1 release message to the HeNB, the S1-AP message carries no special identification indicating the support for local routing optimization. After receiving the S1-AP message, the HeNB deletes all context information related to the UE including the first type of UE context information. The details of the TAU procedure are omitted herein as being identical to the related art.

If no TAU procedure occurs in the UE, the HeNB sets a timer when it stores the first type of UE context information. If the timer expires, the HeNB deletes the first type of UE context information.

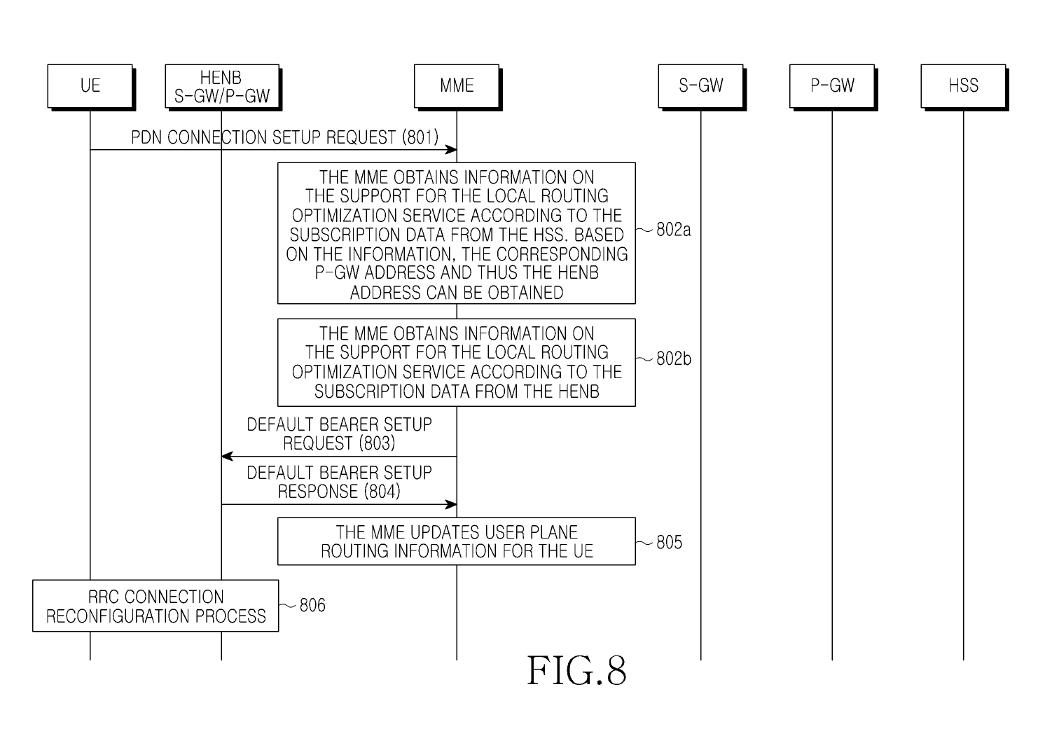

According to an exemplary embodiment of the present invention, an activation process for the local routing optimization is illustrated in FIG. 8.

Referring to FIG. 8, the following description is given, in which technical details irrelevant to the present disclosure are omitted for conciseness in explanation.

At step 801, a UE transmits a PDN connection setup request message to an MME, requesting to activate a local routing optimization service.

At step 802, there are two approaches for the MME to find the address of the HeNB.

According to a first approach, at step 802a, the MME obtains information on the support for the local routing optimization service according to the subscription data from the Home Subscriber Server (HSS). Based on the information, the corresponding P-GW address and thus the HeNB address can be obtained as the HeNB and the P-GW comprise a same entity.

According to the second approach, at step 802b, the MME determines that the activation request is one requesting to activate the local routing optimization service and can obtain the HeNB address according to the S1 connection setup message from the HeNB.

At step 803, the MME transmits a default bearer setup request message to the HeNB.

At step 804, the HeNB updates the stored user plane information for the UE and transmits a default bearer setup response message to the MME.

At step 805, after receiving the response message, the MME updates the user plane routing information for the UE.

At step 806, a process for releasing an RRC connection is performed, whose details are omitted herein as being identical to the related art.

While the invention has been shown and described with reference to certain exemplary embodiments thereof, it with be understood by those skilled in the art that various changes in form and details may be made therein without departing from the spirit and scope of the present invention defined by the appended claims and their equivalents.

1. A method for managing user context by a Home evolved NodeB (HeNB), the method comprising:
requesting, by a Mobility Management Entity (MME), the HeNB to reserve a first type of User Equipment (UE) context information;
obtaining, by the HeNB, the MME of the UE according to the first type of UE context information after receiving data; and
notifying, by the HeNB, the MME of an arrival of the data.

2. The method of claim 1, wherein the MME determines an active local routing optimization service based on the UE context information.

3. The method of claim 2, wherein the message transmitted from the MME to the HeNB comprises identification indicating support for the local routing optimization.

4. The method of claim 3, wherein the first type of UE context information comprises Evolved Packet System (EPS) bearer context information corresponding to a Serving Gateway (S-GW) and a Public Data Network (PDN) Gateway (P-GW).

5. The method of claim 3, further comprising:
transmitting, by the MME, a UE context release response message to the HeNB in order to request to release an S1 connection.

6. The method of claim 5, wherein the message for the S1 connection release includes identification indicating the support for the local routing optimization.

7. The method of claim 1, wherein the message transmitted from the MME to the HeNB comprises a bearer update request message.

8. The method of claim 1, wherein the message transmitted from the MME to the HeNB comprises a UE context release response message.

9. The method of claim 1, wherein the HeNB transmits a response message to the MME after reserving the first type of UE context information.

10. The method of claim 9, wherein the response message transmitted from the HeNB to the MME comprises a bearer update response message.

11. The method of claim 9, wherein the response message transmitted from the HeNB to the MME comprises a UE context release complete message.

12. The method of claim 9, wherein the response message transmitted from the HeNB to the MME comprises identification for the local routing optimization.

13. The method of claim 12, further comprising:
reserving, by the MME, information on an Internet Protocol (IP) address and a tunnel identification (ID), which the HeNB uses for the user plane, after receiving the response message comprising identification for the local routing optimization.
